(19) United States
(12) Patent Application Publication
(10) Pub. No.: US 2022/0071101 A1
(43) Pub. Date: Mar. 10, 2022

(54) Plant Cultivation

(71) Applicant: Dennis Mark Germishuys, Irene (ZA)

(72) Inventor: Dennis Mark Germishuys, Irene (ZA)

(21) Appl. No.: 17/418,049

(22) PCT Filed: Nov. 28, 2019
(86) PCT No.: PCT/IB2019/060282

§ 371 Date: Jun. 24, 2021

(30) Foreign Application Priority Data
Nov. 29, 2018 (ZA) 2018/08074

(51) Int. Cl. A01G 7/06; G06N 3/08; G06T 7/00; G06K 9/62

(52) U.S. Cl. CPC A01G 7/06; G06N 3/08; G06T 2207/20081; G06K 9/6268; G06T 2207/30188; G06T 7/0002

(57) ABSTRACT

The invention provides a plant cultivation system and a method of cultivating plants. The system includes plant sensors in the form of image sensors, arranged to capture digital plant images; processing hardware including a processor, a data storage facility in communication with the processor and input/output interfaces connectable to the plant sensors and in communication with the processor, the hardware being configured to implement a convolutional neural network (CNN) trained from a library of plant images to recognize predefined plant conditions from the digital plant images captured by the image sensors and to provide a matching score of a plant image when compared to the predefined plant conditions with which the CNN has been trained; and a reference library containing treatment regimes associated with predefined plant conditions, the output interface of the processing hardware arranged to present the predefined plant condition and associated treatment regime to a user.

### CROSS-REFERENCE TO RELATED APPLICATIONS

This application is the United States national phase of International Application No. PCT/162019/060282 filed Nov. 28, 2019, and claims priority to South African Patent Application No. 2018/08074 filed Nov. 29, 2018, the disclosures of which are hereby incorporated by reference in their entirety.

### BACKGROUND OF THE INVENTION

### Field of the Invention

The present invention relates to plant cultivation. In particular, the invention relates to a plant cultivation system and a method of cultivating plants.

### Description of Related Art

The inventor identified a need to cultivate plants with a minimum of human intervention. The requirement was also to address plant conditions and disease and pest infestation as soon as possible and to implement corrective actions as soon as such conditions and infestations are detected.

It is an objective of the present invention to address this requirement.

### SUMMARY OF THE INVENTION

According to a first aspect of the invention, there is provided a plant cultivation system, which includes

plant sensors in the form of image sensors, arranged to capture digital plant images;

processing hardware including a processor, a data storage facility in communication with the processor and input/output interfaces connectable to the plant sensors and in communication with the processor, the hardware being configured to implement a convolutional neural network (CNN) trained from a library of plant images to recognize predefined plant conditions from the digital plant images captured by the image sensors and to provide a matching score of a plant image when compared to the predefined plant conditions with which the CNN has been trained; and

a reference library containing treatment regimes associated with predefined plant conditions, the output interface of the processing hardware arranged to present the predefined plant condition and associated treatment regime to a user.

The image sensors may be selected from any one or more of visible spectrum sensors, multispectral sensors, hyperspectral sensors, thermographic sensors and

Chlorophyll fluorescence sensors.

The plant sensors may additionally include environmental sensors selected from humidity sensors, temperature sensors, pH sensors and CO₂ sensors, and the like.

The reference library may include a plant disease database, an insect and pest database and a weather database.

The CNN may be trained with data from the reference library to predict plant growth and yield.

The plant cultivation system may include a control system and environmental control arrangement, the control system controllably connected to the environmental control arrangement, in use to control a plant cultivation environment.

The environmental control arrangement may include dosing pumps, water pumps, humidity controllers and temperature controllers and the like.

The plant cultivation system may be arranged into zones with associated plant sensors and an environmental control arrangement per zone.

Each zone may be defined in terms of global positioning system (GPS) coordinates.

The invention extends to a method of cultivating plants, which includes

receiving plant information from plant sensors, the plant information including digital plant images;

processing the digital plant images with processing hardware, which includes a CNN trained from a library of plant images to recognize predefined plant conditions from the digital plant images and to provide a matching score of a plant image compared to the predefined plant conditions with which the CNN has been trained;

accessing a reference library containing treatment regimes associated with predefined plant conditions; and

presenting predefined plant conditions and associated treatment regimes based on the digital plant images to a user.

The method may include the earlier step of pre-processing digital plant images by means of any one of exposure adjustment, contrast adjustment, gamma correction, rotation, normalization, Sobel filtering and image scaling.

The step of processing the digital plant images may include learning techniques such as logistic regression, linear discriminant analysis, K-nearest neighbours, decision trees, random forests, Gaussian Naive Bayes techniques and support vector machine techniques.

The step of processing the digital plant images may further includes learning techniques selected from any one or more of image moments, Haralick textures and colour histograms.

The matching score may be in the form of an overall health score, which takes in to account all the relevant environmental- and plant factors.

The step of presenting predefined plant conditions and associated treatment regimes based on the plant images includes providing a visual alert schedule.

The step of providing a visual alert schedule may include providing alerts in terms of humidity, light, pH, temperature, mineral imbalance, CO₂ levels, insects on plants and plant disease detected and other custom alerts.

The invention is now described, by way of non-limiting example, with reference to the accompanying figure(s).

### BRIEF DESCRIPTION OF THE DRAWINGS

In the figure(s):

FIG. 1 shows an overview of a plant cultivation system in accordance with one aspect of the invention is shown;

FIGS. 2 and 3 show graphical overviews of a method of cultivating plants in accordance with another aspect of the invention;

FIG. 4 shows a graphical overview of events being detected in the method of FIGS. 2 and 3;

FIG. 5 shows a graphical overview of the reference databases forming part of the system of FIG. 1;

FIG. 6 shows a plant treatment method forming part of the method of FIGS. 2 and 3;

FIG. 7 shows remote monitoring of the method of FIGS. 2 and 3; and

FIG. 8 shows an alert display forming part of the system of FIG. 1.

In the figures, like reference numerals denote like parts of the invention unless otherwise indicated.

### DESCRIPTION OF THE INVENTION

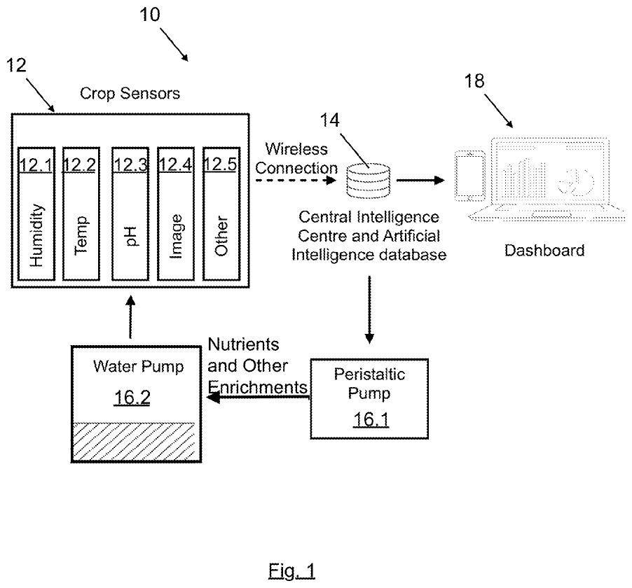

In FIG. 1 an overview of a plant cultivation system (10) in accordance with one aspect of the invention is shown. The plant cultivation system (10) includes a set of sensors (12), of which a few examples are shown as humidity sensors (12.1), temperature sensors (12.2), pH sensors (12.3), Image sensors (12.4) and various other sensors (12.5).

All the sensors are able to record data and wirelessly to transfer the data to a processing hardware in the form for a central intelligence centre (14).

The central intelligence centre (14) are controllably connected to an environmental control arrangement in the form of a control system (16), of which only a dosing pump (16.1) are shown. The dosing pump (16.1) is operable to dose feed water of the plants with various types of chemical and biological treatments. The control system (16) further includes an irrigation system (16.2) downstream of the dosing pump (16.1) for distributing treated water to plants being cultivated.

The central intelligence centre (14) is connected to output interfaces in the form of remote monitors (18) which may include mobile devices, such as mobile phones or laptop computers or stationary devices such as desktop computers onto which recorded data can be displayed.

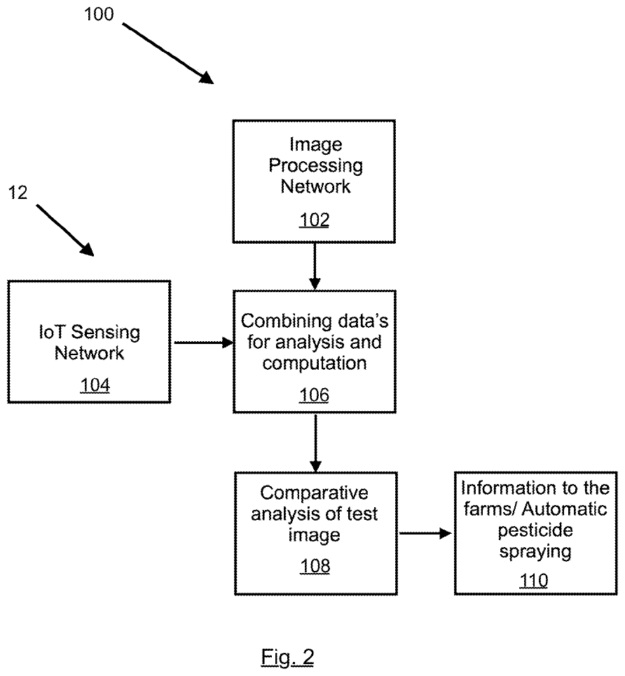

FIG. 2 show a graphical overview of a method (100) of cultivating plants. The image sensors (12.4) are connected into an image processing network (30), which receives digital plant images of each plant at (102). The other physical sensors (12) such as the humidity sensors (12.1), temperature sensors (12.2) and pH sensors (12.3) collects environmental data of the plant's environment at (104). The data collected at (102) and (104) are processed by combining the data into a plant condition database at (106). The plant condition database data (106) is then fed into a reference database at (108) to identify and predict predefined plant conditions (also at 108). The outputs of the identified plant conditions are then fed into a treatment regime at (110) for treatment of the plants.

FIG. 3 shows another graphical overview of a method (100) of cultivating plants. In particular, a zoning function is shown, where all collected plant data from the sensors (12) is zoned in particular areas of different plant varieties and areas of same plant varieties. The image data (102) and sensor data (104) are shown and the reference data (108) of weather conditions, diseases, subject matter experts and pests are shown. The central intelligence centre (14) is shown and the remote monitors (18) are shown.

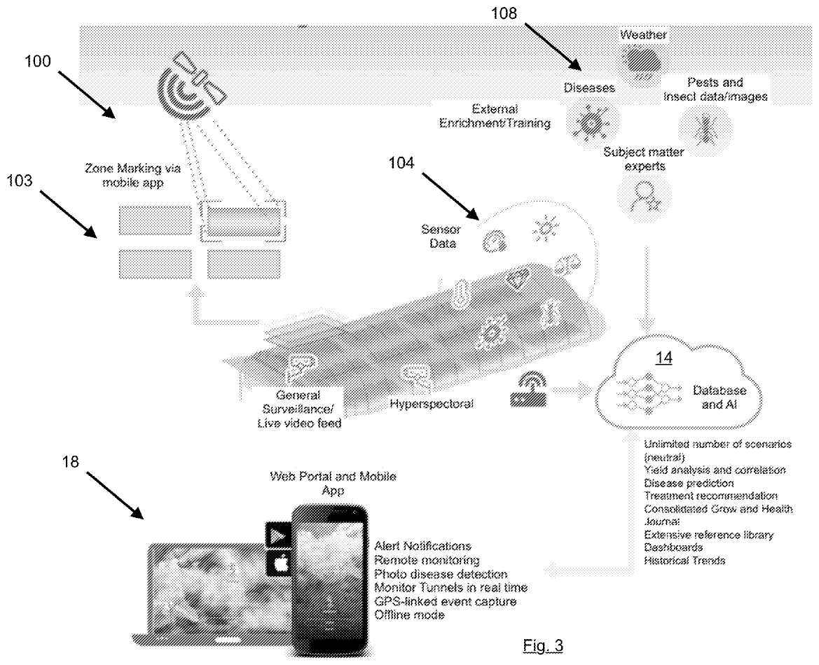

FIG. 4 shows classes of events (120) that can be identified by the system, such as crop events (120.1), environmental events (120.2), external events (120.3) and disease and pest events (120.4).

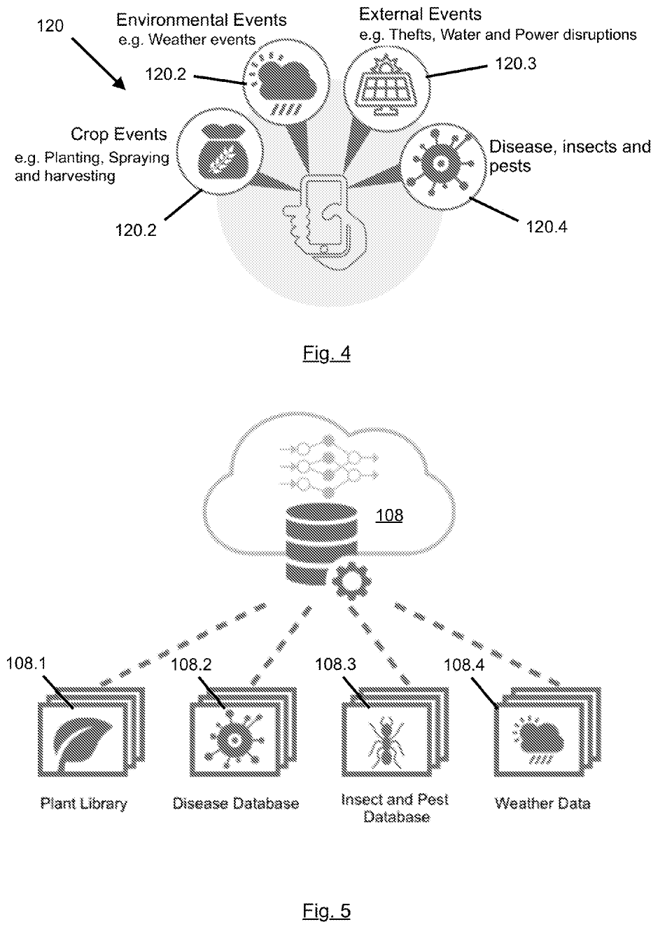

FIG. 5 shows the detail of the reference database (108), which includes a reference plant library (108.1), a reference disease library (108.2), a reference pest database (108.3) and a reference weather database (108.4).

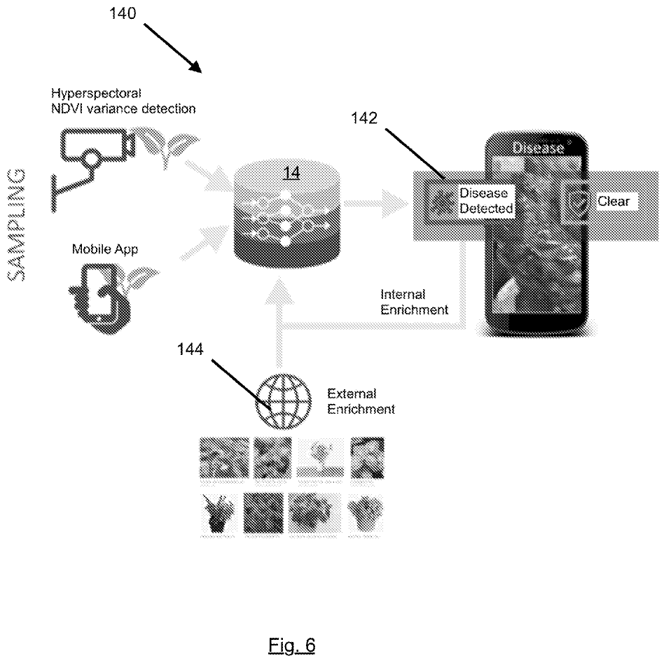

FIG. 6 shows a method (140) of applying a treatment regime to the plants, which includes processing data in the central intelligence centre (14) and applying internal treatments (142) and external treatments (144) to the plants. In this context, internal treatments are defined as treatments based on data from the plants being monitored whereas external treatments relate to treatments based on external data sources.

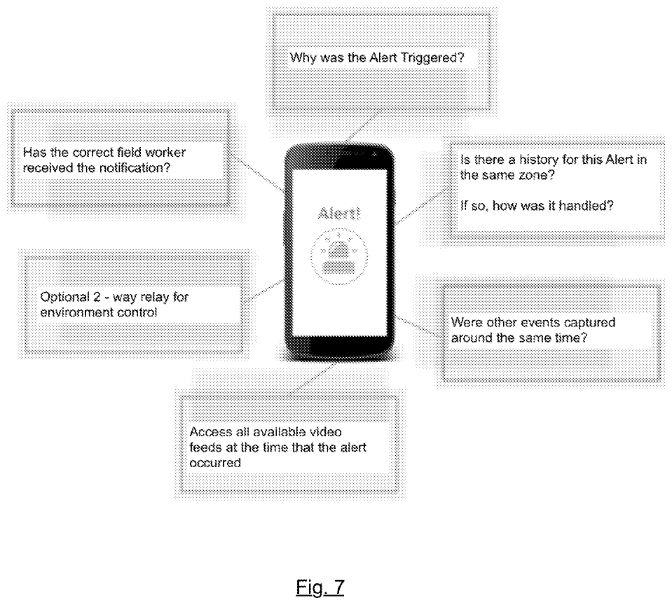

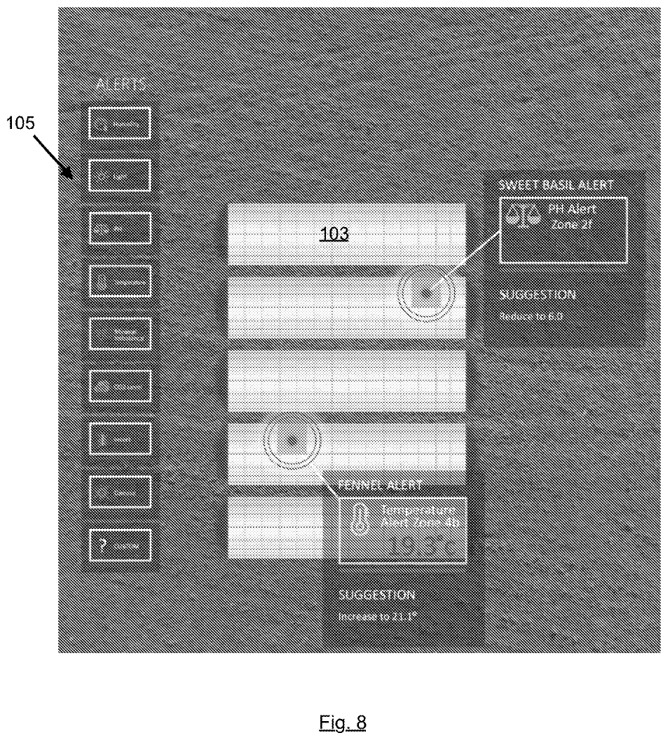

FIGS. 7 and 8 shows the interaction of the central intelligence centre (14) with the remote monitors (18). In FIG. 7, the functionality on a mobile telephone is shown and includes: access to video feeds, environmental controls, notifications to workers, triggering of alerts, history of alerts in the same zone, other events captured during the same time. In FIG. 8 the various zones (103) are shown schematically and the type of alerts (105) that can be generated by the central intelligence system (14) are shown. The alerts (105) includes alerts for: humidity, light, pH, temperature, mineral imbalance, CO₂ levels, pests, diseases and other custom alerts that can be programmed. FIG. 8 also shows a particular treatment regime which should be followed, for example to reduce the pH in a particular zone or the change in temperature in a particular zone.

The inventor is of the opinion that the invention, as described provides a new method of cultivating plants and a new plant cultivation system, which will be of particular use in cultivating plants by identifying certain conditions and managing them timeously.

1. A plant cultivation system, which comprises
plant sensors in the form of image sensors, arranged to capture digital plant images;
processing hardware comprising a processor, a data storage facility in communication with the processor and input/output interfaces connectable to the plant sensors and in communication with the processor, the hardware being configured to implement a convolutional neural network (CNN) trained from a library of plant images to recognize predefined plant conditions from the digital plant images captured by the image sensors and to provide a matching score of a plant image when compared to the predefined plant conditions with which the CNN has been trained; and
a reference library containing treatment regimes associated with predefined plant conditions, the output interface of the processing hardware arranged to present the predefined plant condition and associated treatment regime to a user.

2. The plant cultivation system of claim 1, in which the image sensors are selected from any one or more of visible spectrum sensors, multispectral sensors, hyperspectral sensors, thermographic sensors and Chlorophyll fluorescence sensors.

3. The plant cultivation system of claim 1, in which the plant sensors additionally include environmental sensors selected from humidity sensors, temperature sensors, pH sensors and CO₂ sensors.

4. The plant cultivation system of claim 1, in which the reference library comprises a plant disease database, an insect and pest database and a weather database.

5. The plant cultivation system of claim 1, in which the CNN is trained with data from the reference library to predict plant growth and yield.

6. The plant cultivation system of claim 1, in which the plant cultivation system comprises a control system and environmental control arrangement, the control system controllably connected to the environmental control arrangement, in use to control a plant cultivation environment.

7. The plant cultivation system of claim 6, in which the environmental control arrangement comprises dosing pumps, water pumps, humidity controllers and temperature controllers.

8. The plant cultivation system of claim 7, in which the plant cultivation system is arranged into zones with associated plant sensors and an environmental control arrangement per zone.

9. The plant cultivation system of claim 8, in which each zone is defined in terms of global positioning system (GPS) coordinates.

10. A method of cultivating plants, which comprises
receiving plant information from plant sensors, the plant information including digital plant images;
processing the digital plant images with processing hardware, which comprises a CNN trained from a library of plant images to recognize predefined plant conditions from the digital plant images and to provide a matching score of a plant image compared to the predefined plant conditions with which the CNN has been trained;
accessing a reference library containing treatment regimes associated with predefined plant conditions; and
presenting predefined plant conditions and associated treatment regimes based on the digital plant images to a user.

11. The method of cultivating plants of claim 10, which comprises the earlier step of pre-processing digital plant images by means of any one of exposure adjustment, contrast adjustment, gamma correction, rotation, normalization, Sobel filtering and image scaling.

12. The method of cultivating plants of claim 10, in which the step of processing the digital plant images comprises learning techniques such as logistic regression, linear discriminant analysis, K-nearest neighbours, decision trees, random forests, Gaussian Naive Bayes techniques and support vector machine techniques.

13. The method of cultivating plants of claim 12, in which the step of processing the digital plant images further comprises learning techniques selected from any one or more of image moments, Haralick textures and colour histograms.

14. The method of cultivating plants of claim 10, in which the matching score is in the form of an overall health score, which takes into account all the relevant environmental- and plant factors.

15. The method of cultivating plants of claim 10, in which the step of presenting predefined plant conditions and associated treatment regimes based on the plant images comprises providing a visual alert schedule.

16. The method of cultivating plants of claim 15, in which the step of providing a visual alert schedule comprises providing alerts in terms of humidity, light, pH, temperature, mineral imbalance, CO₂ levels, insects on plants and plant disease detected.

17. (canceled)

18. (canceled)
